(19) United States
(12) Patent Application Publication
(10) Pub. No.: US 2015/0193828 A1
(43) Pub. Date: Jul. 9, 2015

(54) SYSTEM AND METHOD FOR TAILORING CONTENT WITHOUT PUBLISHER ACCESS TO CONSUMER DATA

(71) Applicant: David Wayne Bulger, Baldwinsville, NY (US)

(72) Inventor: David Wayne Bulger, Baldwinsville, NY (US)

(21) Appl. No.: 14/663,952

(22) Filed: Mar. 20, 2015

Related U.S. Application Data
(63) Continuation of application No. 14/308,814, filed on Jun. 19, 2014, now abandoned.
(60) Provisional application No. 61/836,949, filed on Jun. 19, 2013.

(51) Int. Cl. G06Q 30/02

(52) U.S. Cl. CPC G06Q 30/0269

(57) ABSTRACT

In some embodiments, dynamically generated, individually tailored content from a content producer may be provided through a content distributor to a consumer without revealing the consumer's identity or exposing any of the consumer's data profile directly to the distributor or producer.

### CROSS-REFERENCE TO RELATED APPLICATION

This application is a continuation of co-pending U.S. application Ser. No. 14/308,814, filed Jun. 19, 2014 which in turns claims the benefit of Provisional Application Ser. No. 61/836,949 filed Jun. 19, 2013, the entire contents of all applications are incorporated herein by reference in their entireties.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

1. Field of the Invention

The embodiments generally relate to the dynamic generation of individually tailored content, where individual consumer data is not visible to or accessible by the content producer or distributor.

2. Description of Related Art

As consumption of editorial and advertising content via online media sources (e.g., desktop and mobile computing/media devices) increases, the opportunities and desires for reaching individual content consumers (“Consumers”) by content producers (“Producers”) via content distributors (“Distributors”) are creating discomfort among Consumers over how, when, where and why Distributors are collecting their personal information and Producers are leveraging that information.

Federal Do Not Track legislation has become an increasingly chilling specter as a perhaps well-intentioned but potentially catastrophic means of protecting Consumer privacy online. In order to meet Consumer content needs, Producers and Distributors should be able to generate the revenue required to produce and distribute content. The majority of this revenue comes from online advertising; by and large, Consumers eschew subscription services, having grown accustomed to free and unfettered access to online content.

Online advertisers are under increasing pressure to efficiently identify and reach desired target audiences; getting the right message in front of the right customers at the right time is a mission-critical objective for marketing executives to ensure advertising dollars are maximally effective. The current practice of “behavioral targeting” (i.e., attempting to create targeting profiles by inferring consumer attributes based on web page visitation patterns) is crude, generally misunderstood and detested by Consumers and, yet, the best chance advertisers have for meeting business objectives. It's a lose-lose proposition that stands to break much of what is valuable about the World Wide Web as the FTC attempts to protect Consumers by shutting down advertiser access to consumer tracking information.

Consumers generally understand that their access to free content is largely underwritten by advertisers. Advertising messages play a significant role in helping Consumers learn, shop and buy. Providing Consumers with a means of controlling access to their personal data in return for the editorial and advertising content of most interest and/or importance to them is a win-win path forward for Consumers, Distributors and Producers.

Conventional systems for protecting information privacy determine quasi-identifiers in data sets useful in re-identifying individual subjects. These conventional systems attempt to generalize, hide or withhold quasi-identifiers in the data sets to protect the privacy of individuals. For example, a subject's salary information can be hidden within aggregate salary information for a group.

Other conventional systems for protecting privacy attempt to generalize the information to prevent re-association with specific subjects. For example, some of these systems replace some or all digits of a subject specific identifier with wildcards to generalize the identifier. In this way, a group of subjects is created in which the group is associated with a non-subject specific identifier. The group lessens the impact of information disclosures on any specific subject while allowing the release of interesting aggregate information.

Samarati et al. “Protecting Privacy when Disclosing Information: k-Anonymity and Its Enforcement through Generalization and Suppression”, Technical Report, SRI International, March 1998, describe a system for protecting privacy based on a theory of k-anonymity. Samarati propose granular access to any sensitive information by applying the minimal set of generalization transformations necessary to create desired groups of size at least “k”. The subject identifying portions of the information are transformed by these generalizations.

These conventional privacy protecting systems assume that access to the underlying data source is available. However, in a typical data-mining environment, the underlying data sets are not necessarily available for access. Moreover, these conventional systems do not work well in mobile environments. Although some conventional systems aggregate subject specific information before it is disclosed to a third party, all personal data must be disclosed to the aggregator.

U.S. Pat. No. 7,707,413, the disclosure of which is incorporated by reference herein in its entirety, attempts to solve this problem in a mobile environment by determining privacy policies surrounding the data in a query for such data, and determines an optional privacy impact indicator based on how satisfying the request increases the current public information about the user. Crowds of users having similar attribute name/values then are optionally determined, and user and optional requestor privacy policies that associate threshold release criteria such minimum crowd size, minimum consideration with the non-public information are determined. A privacy agreement then is reached for the disclosure of the requested non-public information based on the compatibility of the requester and user privacy policies. Privacy protecting transformations are optionally determined and applied to create crowds or groups associated with the requested attribute.

These privacy protecting systems typically assume that all the relevant information for a large group of subjects is simultaneously available in a single location. However, information about users is not always centralized and/or if centralized is not usually available from the network operator. Therefore, systems and methods for protecting extracted knowledge or data, and using this data to provide personalized content to the user would be useful.

### SUMMARY

It is a feature of an embodiment to provide methods and systems for providing tailored content to consumers, while at the same time protecting the privacy of consumer information. It is another feature of an embodiment to provide methods and systems that enable Consumers to voluntarily provide their personal information, thereby negating the need to gather that information without the Consumer's knowledge and consent. It also is a feature of an embodiment to provide for a standardized and protected method of maintaining a robust online presence that enhances online content and commerce interactions without sacrificing personal identity or having to create robust profiles on a site-by-site basis.

In accordance with these and other features, there is provided a method for establishing a “Rosetta Stone” that maintains Consumer privacy while also providing Producers with an ability to appropriately and accurately target editorial and advertising content without requiring a lengthy profile questionnaire or attempting to collect behavioral information surreptitiously. Consumers can create a secure profile that includes, for example, demographic, environmental, attitudinal, behavioral, shopping and preferences data. These data then may be encapsulated and converted into a de-identified “badge” that can be read by Distributors.

In another embodiment, these badges may be matched with the Distributor's advertisers (or ad network, as appropriate). Advertisers may create a storehouse or database of objects, such as ad objects, based on one or more desired Consumer badge attributes. When a Distributor recognizes a badge or one or more badge attributes, the appropriate objects from the advertiser's storehouse are dynamically assembled and presented to the Consumer. This embodiment can be referred to as the “Advertiser” embodiment.

In another embodiment, Distributors leverage badge information to dynamically assemble some or all of the Consumer's experience, including user experience, navigation and presented content elements. These presentations are independent to and irrespective of any customization the Distributor may leverage based on individual user authentication data or distributor-specific profile information. This embodiment can be referred to as the “Publisher” embodiment.

For the purposes of this embodiment, the notions of Producer and Distributor are abstract; it is entirely possible that an entity may be both a Producer and a Distributor, especially in the Publisher embodiment. However, because the functionality within the Producer and Distributor functions typically is distinct, this embodiment treats them as separate entities.

These and other features will be readily apparent from the detailed description that follows.

### BRIEF DESCRIPTION OF THE FIGURES

To embodiments may be described in more detail by reference to the following drawings in which like reference numerals denote like elements, and in which:

FIG. 1 illustrates overall constituent (i.e., Consumer, Distributor, Producer) interactions for various embodiments described herein;

FIG. 2 illustrates a method as it relates to Consumers;

FIG. 3 illustrates a method as it relates to Producers for various embodiments;

FIG. 4 is an annotated flowchart that defines the processes Producers leverage to create tailored content objects.

FIG. 5 is a process diagram depicting a method as it related to Distributors for various embodiments.

FIG. 6 is, an annotated flowchart that describes the algorithm structure for generating Badges.

### DETAILED DESCRIPTION

Embodiments described herein allow for the presentation of a Producer's dynamically generated, individually tailored content to individual anonymous consumers via a media Distributor. Embodiments also allow consumers to enter data voluntarily, and receive tailored content without reference to the consumer's private data.

Throughout this description, the terms “Consumer,” “Distributor,” and “Producer” denote individuals, companies, organizations, and the like. Consumer typically refers to individuals, although a consumer could refer to an organization or company that receives content. Distributor typically refers to individuals and organizations that distribute content to consumers, either remotely via a web-based or mobile-based environment, or through physical content distribution directly to consumers, such as print, radio, or television advertising or promotion. Producer typically refers to individuals and organizations that produce content for distribution to Consumers, and can include, for example, advertisers, product manufacturers, event organizers and producers (athletic, music, entertainment, etc.), and the like.

Throughout this description, the term “badge” denotes an anonymous identifier that can be used to identify a Consumer's specific traits without identifying the identity of the Consumer. Thus, a “badge” can be created that includes data pertaining to individual Consumers, but excluding privacy information such as the Consumer's name, address, phone number, and other information that could be used to identify the Consumer. In one embodiment, the badge may be represented as an encoded Unicode string, indecipherable without a decoding template and meaningless if viewed in its native decoded format. The badge may have an associated icon that represents one or more unique, non-personally identifiable data attributes associated with the badge. The badge may also have an associated name that represents one or more badge attributes.

Throughout this description, the term “Badge Development Portal” refers to a website or mobile application that can be used to collect questionnaire information from Consumers for the purposes of generating a badge.

Throughout this description, the term “Badge Generator” denotes a web server application that can evaluate Consumer questionnaire data collected via a Badge Development Portal, and that may assign a badge for the individual Consumer.

Throughout this description, the term “Badge CDN” refers to a secure web server that may provide a content distribution network for delivering badge information, as appropriate, to authenticated Distributors and Producers.

Throughout this description, the term “Badge Maps” refers to a secure web utility that can provide a data element dictionary (a variable list with each variable's acceptable values) representing potential Consumer data attributes.

Throughout this description, the term “Tailored Content Object Library” denotes a data warehouse that may contain all or a portion of a Producer's content objects (e.g., text, image, audio, video, animations, etc.) that may be used during content tailoring for an individual Consumer based on that Consumer's badge.

Throughout this description, the term “Tailored Content Object Generator” refers to a website or mobile application that may support tailored content development by helping Producers link individual content elements to content display rules for each content object.

Throughout this description, the term “Tailoring Criteria” refers to one or more variable-value combinations that may be used to determine which content elements should be displayed based on individual badge characteristics.

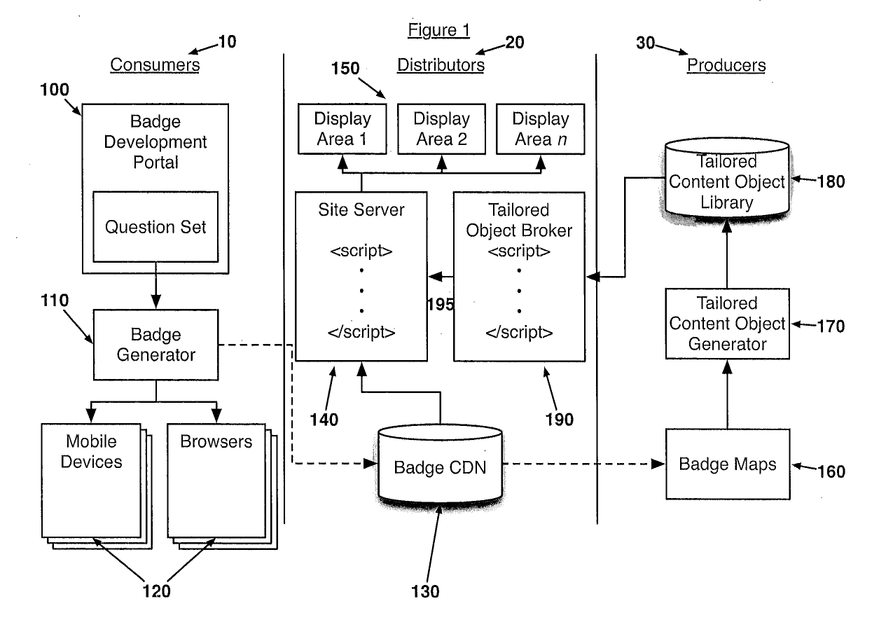

In one embodiment, FIG. 1 illustrates the overall interactions between Consumers 10, Distributors 20, and Producers 30. For example, in one embodiment Consumers complete a question set or questionnaire 100 via a dedicated profile development website (e.g., “Badge Development Portal”), or other suitable mechanism to enable entry of answers to questions either directly or remotely. The types of questions included in question set 100 include those that would be expected to solicit answers identifying certain behaviors of Consumers that might benefit a Producer. For example, questions that elicit answers relating to one or more elements of demographic, information (age, sex, residence), purchasing tendencies, motivations, barriers, attitudes, preferences, goal setting preferences, behavioral intent, readiness to change, perceived susceptibility, perceived severity, cues to action, volitional control, self-efficacy, locus of control, adoption preferences, brand preferences, shopping habits, work habits, income level, family makeup, geography, activities of daily living, treatment adherence dispositions, wellness attributes and habits, interests or hobbies, favorite movies and TV shows, musical preferences, favorite sports teams, leisure activities, dining preferences, and the like might be included in question set 100.

This question set can be algorithmically converted into an anonymous, addressable “badge” in a badge generator 110 that Consumers add to their web browser or mobile phone settings as a resident badge 120 on the Consumer's particular device. Generating an anonymous, addressable badge via badge generator 110 based on the answers to question set 100 can be accomplished by using a proprietary algorithm that uses raw Consumer response data and inferred data from one or more raw Consumer response data elements, as well as “best fit” cluster analysis from the datasets of other Consumers to accurately catalog user attributes in a meaningful way for tailored content presentation.

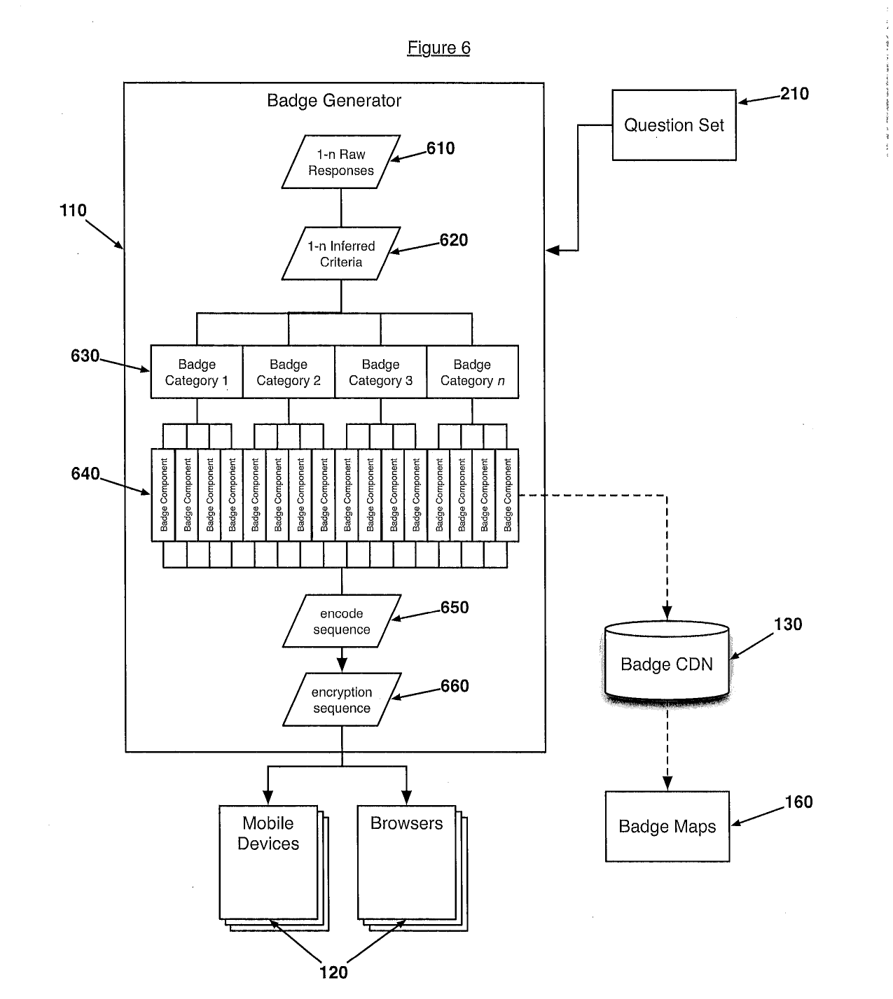

FIG. 6 depicts the structural flow of a suitable algorithm that can be utilized with, or otherwise contained within the Badge Generator 110. The Question Set 210 within the Badge Development Portal 100 may result in 1-n raw responses 610 (e.g., Question: “What is your gender?” has raw response options “Female” and “Male”). From the totality of raw responses, 1-n inferred criteria 620 can be generated.

For instance, to infer a Consumer's technology adoption style, the algorithm can preferably follow this general structure:

```
techAdoptMatrix = [ [ 0 for i in range(5) ] for j in range(5) ]
  innovatorArray = [25,15,10,3,0]
  earlyAdopterArray = [15,7,5,1,0]
  earlyMajorityArray = [0,0,0,0,0]
  lateMajorityArray = [−15,−7,−5,−1,0]
  laggardArray = [−25,−15,−10,−3,0]
x = 0
tech_adopt = 0
for j in range(5):
  techAdoptMatrix[0][j] = laggardArray[j]
  techAdoptMatrix[1][j] = lateMajorityArray[j]
  techAdoptMatrix[2][j] = earlyMajorityArray[j]
  techAdoptMatrix[3][j] = earlyAdopterArray[j]
  techAdoptMatrix[4][j] = innovatorArray[j]
while (x <= 7):
  y = personaRatings[x] − 1
  z = matrix_tech_adopt[x] − 1
  tech_adopt = tech_adopt + techAdoptMatrix[y][z]
  x = x + 1
if (tech_adopt >= 40):
  putAnswers.tech_adopt = 1
elif (tech_adopt >= 21):
  putAnswers.tech_adopt = 2
elif (tech_adopt >= −20):
  putAnswers.tech_adopt = 3
elif (tech_adopt >= −39):
  putAnswers.tech_adopt = 4
else:
  putAnswers.tech_adopt = 5
```

Inferred criteria 620 then can be clustered into one of n Badge Categories 630. These categories may have little direct association with the Question Set 210 but will have actionable meaning for Producers 20 during content tailoring design and development activities. Each Badge Category 630 may be further segmented into individual Badge Components 640 that represent the variable-value combinations identified in Badge Maps 160, accessed by Producers 20 via the Badge CDN 130. In one embodiment, only the variable-value combination possibilities may be transferred, not the individual Consumer's 10 response data. Badge generation 110 can be completed by passing the Consumer's 10 categorized, componentized responses through an encode sequence 650, where the responses are converted from their raw state (e.g., gender=“Male” to gender=2), followed by an encryption sequence 660 that uses one or more commercially available data encryption applications to generate a unique, secure badge that Consumers 10 can easily plug into their mobile device and/or browser preferences 120 to receive individually tailored content anonymously.

The anonymous badge generated by badge generator 110 can be used by Distributors 20 and Producers 30 to provide tailored content to the Consumer 10. Distributors and Producers may access global badge attributes contained within each badge via a Badge content distribution network (“Badge CDN”) 130. Distributors may connect the Badge CDN 130 to their sites' server-side scripting libraries 140, linking the scripts to appropriate editorial and/or advertising browser or mobile display areas 150. Scripting libraries 140 typically are created by Distributors or Producers as part of routine website and mobile application operations and maintenance; Badge CDN connectivity is handled in a manner consistent with CDN connectivity best practices (e.g., url “include” statements or Javascript header scripts).

Producers 30 may leverage the Badge CDN 130 to generate Badge Maps 160 that can be used to create content objects based on variable-value combinations for desired Consumer attributes by using a Tailored Content Object Generator 170. This generator supports Producers' tailored content development by helping Producers link individual content elements (e.g., text, image, audio, video, animations) to content display rules for each content object; these rules can be simple or complex “if-then” statements based on variable-value combinations accessible via a Consumer's badge. This process is further described below, but preferably the Object Generator 170 exists to help Producers ensure they have appropriate content elements for all desired tailoring criteria contained within a badge.

These content objects can be stored in a Tailored Content Object Library 180 that can be accessed by Distributors 20 (in whatever manner Distributors normally access Producer content) using the Producer's unique Producer Key. The Producer's unique Producer Key can be any character, series of characters, or other password activation mechanism used to provide limited access to a database. At runtime, Distributor server-side scripts (collectively, the “Tailored Object. Broker” 190) identify whether a Consumer's web browser or mobile settings include badge information; if true, appropriate objects from the Producer's Tailored Content Object Library 180 can be assembled for presentation in the Consumer's web browser/mobile application 195.

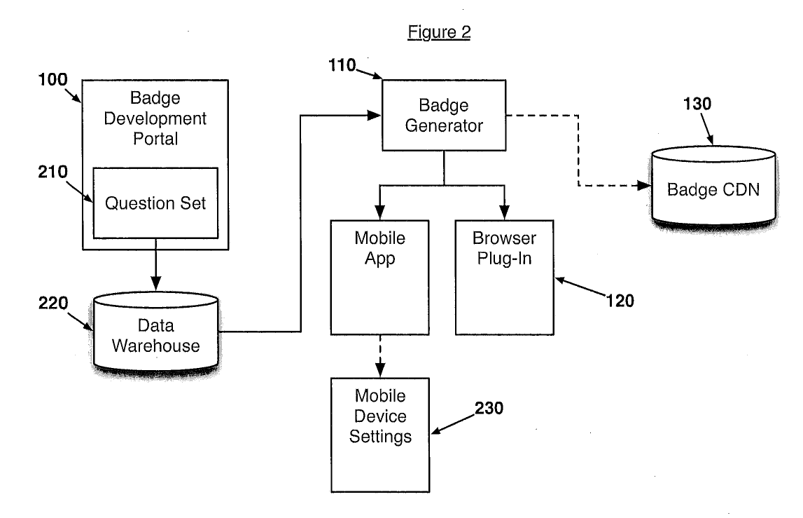

As depicted in FIG. 2, this embodiment may facilitate an easy, efficient Consumer experience that can result in a robust data pool (ease of use is integral to this method since without Consumer data, the method is impotent). Consumers can interact with a Badge Development Portal 100 to complete a Question Set 210, or questionnaire, that includes one or more questions/activities related to the Consumer's demographics, environment, attitudes, perceptions, motivations, barriers and other cognitive/behavioral information necessary for tailoring content to the individual Consumer within the context of some content display (e.g., a tailored ad, newsfeed or entertainment experience).

Raw Question Set data may be stored in a Data Warehouse 220. Personally identifiable information preferably is segregated from the rest of the data, linkable only through a secure, encrypted primary key. Raw Question Set data can transformed for Distributor and Producer use via a Badge Generator 110. The Badge Generator may include an algorithm set that encodes Consumer data as an encrypted data string (commonly referenced in this document as a “badge”) that can be used to generate individually tailored content without the need to access the Consumer's raw data in any way.

A Consumer's badge is anonymously uploaded to a central Badge CDN 130 and can be downloaded by the Consumer to one or more personal web browsers 120 and/or mobile device settings list using a badge app 230, or other similar program that can be uploaded to a Consumer's computer or mobile device. The Badge CDN 130 also may include a dashboard that provides aggregated data on the types and numbers of available consumer badges. Consumers can maintain their private data set using the Badge Development Portal 100, and can access the Portal 100 and update and/or revise their private data as the need may arise.

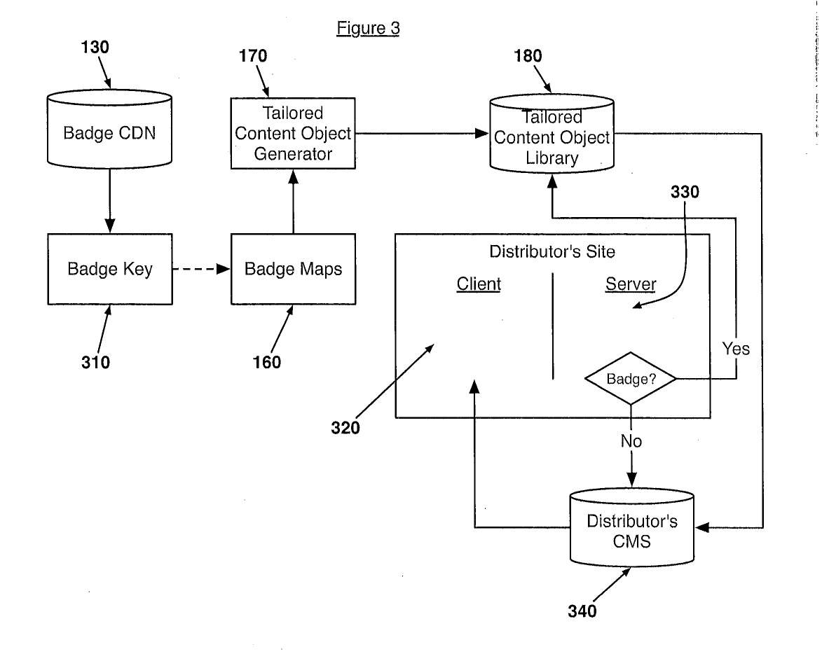

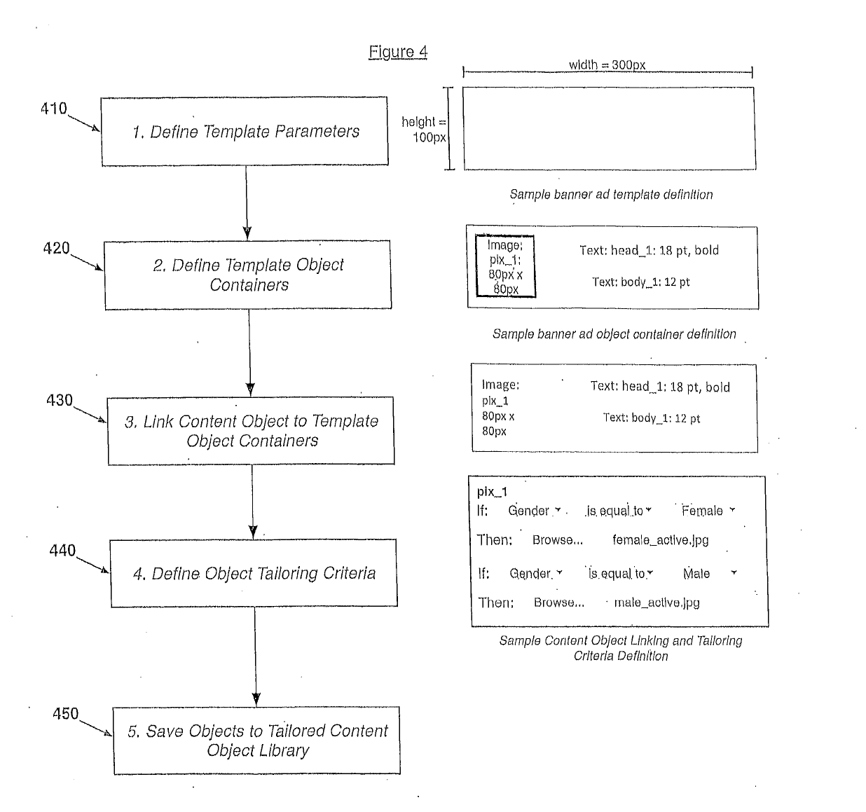

FIG. 3 illustrates a method as it relates to Producers for various embodiments. Producers interested in creating tailored content can download Badge Keys 310 from the Badge CDN 130. The Badge Key, a unique access identification string used to access the Badge CDN, is generated (as a unique, randomized Unicode string for the purpose of private, secure Producer and Distributor authentication) for an individual Producer or Distributor during the registration process for accessing the Badge Map 160. The Badge Key 310, when used within a Tailored Content Object Generator 170, may function as a data dictionary, or Badge Map 160, that identifies required content objects based on applicable variable-value combinations for desired Consumer attributes (this process is further described in the FIG. 4 discussion, below). Content objects can be uploaded into a Tailored Content Object Library 180 that can be accessed by Distributors in whatever manner they normally access a participating Producer's content (e.g., via Distributor's CMS 340). At runtime, Distributor server-side scripts 330 can identify whether a Consumer's web browser or mobile settings include Badge information, and if so, appropriate objects from the Producer's Tailored Content Object Library 180 are assembled in real-time using Distributor client-side scripts 320 for presentation in the Consumer's web browser/mobile application.

FIG. 4 depicts a process for defining tailoring attributes for content objects, and may include five basic processes:

Define template parameters 410: this process includes providing metadata information related to the size (e.g., height, width, runtime length, max word count, etc.), media type (e.g., text only, image only, text with image, animation, video, etc.) and identification attributes (e.g., template name, ID, etc.) for each content object.

Define template object containers 420: each template may include one to many media objects (e.g., text, image, animation, audio, video, etc.); here, virtual containers can be identified in terms of size, type and location within the template. All container parameters can be assigned tailoring criteria as if they were content elements as described below in process 440.

Link content object to template object containers 430: each template object container may include one to many media objects as defined in 420; here, physical elements can be matched to each container and tagged with tailoring rules as outlined below in 440.

Define object tailoring criteria 440: for each template object (and, if desired, each template object container), available variable-value combinations from the Badge Key 310 can be selected and attached as metadata to the container. For content objects that may include within-object tailoring, all within-object tailoring criteria are also supplied (e.g., a text object may consist of one to many unique text elements, such as

if country != null, then text_object =
“This country's flag colors are [text_object_1]
if country == “USA”, then text_object_1 = “red, white and blue.”
if country == “Germany”, then text_object_1 =
“red, black and yellow.”).

Save objects to Tailored Content Object Library 450: Once all object tailoring criteria have been defined, the objects and their metadata may be uploaded to the Tailored Content Object Library 180 along with a Producer Key that Distributors use for secure access to the Producer's content objects at runtime (this process is described in greater detail below).

The process described above (paragraphs 48-52) preferably is functionally similar for both embodiments of this method (Advertisers and Content Producers).

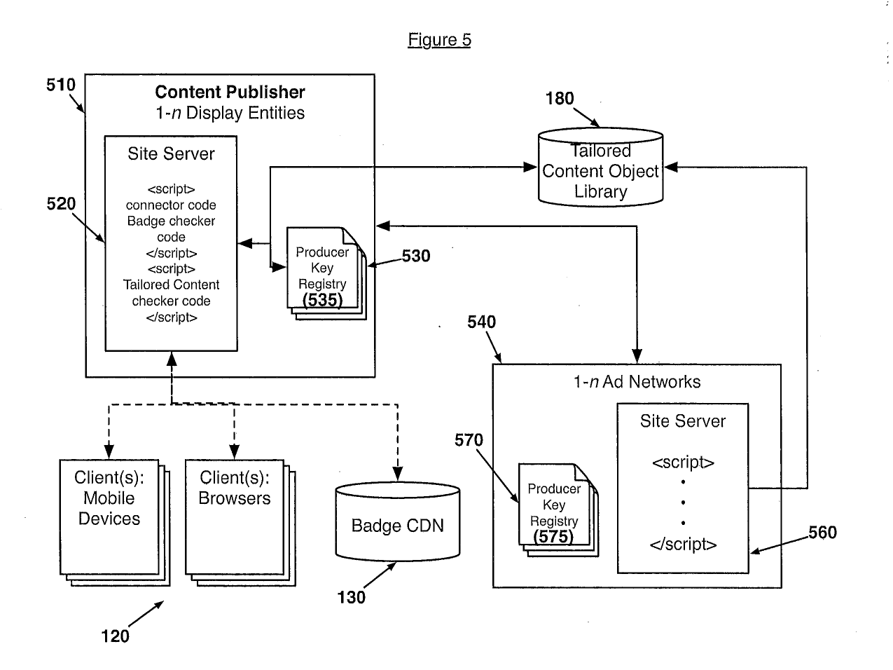

As depicted in FIG. 5, Distributor interaction preferably is intended to deliver maximum functionality with minimal effort for both embodiments. For both embodiments, Distributors may add server-side code 520 to their Display Entity 510 (e.g., web site, mobile app, game network, etc.) that connects their Display Entity 510 to the Badge CDN 130 and checks for badges on client Viewer Entities 120 (e.g., web browser, mobile device, game console, etc.).

For the Producer embodiment, Distributors may add server-side code 520 that connects their Display Entity 510 to the centralized Tailored Content Object Library 180 and may add a server-side Producer Key Registry page 530 where Producer Keys 535 for each participating Producer are stored.

In the Advertising embodiment, there are preferably two Distributors: the Ad Network 540 and the Content Publisher 510. In this embodiment, the Ad Network 540 may add server-side code 560 that connects their network to the centralized Tailored Content Object Library 180 and the server-side Producer Key Registry page 570 for storing the Producer Keys 575 of participating Advertisers. The Publisher can add server-side code 520 that checks for the presence of tailored content each time the Ad Network 540 passes content to the Display Entity 510. If present, the Publisher selects the appropriate Content Objects based on the client's Badge ID; otherwise, the Ad Network's content is passed and processed as usual.

While the invention has been described with reference to particularly preferred embodiments, those having ordinary skill in the art will appreciate that various modifications may be made to the invention without departing from the spirit and scope thereof.

What is claimed is:

1. A method for delivering individually tailored content to a consumer anonymously, the method being implemented on a computer system that includes one or more physical processors executing computer program instructions which, when executed, perform the method, the method comprising:
collecting consumer profile data associated with a consumer;
translating the consumer profile data into a usable but non-personally identifiable form, wherein the translated consumer profile data indicates one or more non-personally identifiable attributes related to the consumer profile data;
creating one or more tailored content objects based on the one or more non-personally identifiable attributes indicated by the translated consumer profile data;
obtaining at least one content object of the one or more tailored content objects for the consumer based on at least one attribute of the one or more non-personally identifiable attributes; and
providing the at least one content object to a user device associated with the consumer.

2. The method according to claim 1, wherein translating the consumer profile data comprises encapsulating the consumer profile data into a badge that consists of non-personally identifiable data such that the non-personally identifiable data comprises human and machine understandable non-personally identifiable data that indicates the one or more non-personally identifiable attributes.

3. The method according to claim 1, wherein creating the one or more tailored content objects comprises identifying, based on the one or more non-personally identifiable attributes indicated by the translated consumer profile data, one or more template object containers associated with one or more variable-value combinations for the one or more tailored content objects.

4. The method according to claim 1, wherein creating the one or more tailored content objects comprises identifying, based on the one or more non-personally identifiable attributes indicated by the translated consumer profile data, one or more variable-value combinations for the one or more tailored content objects, wherein the one or more variable-value combinations enable presentation, within a content object of the one or more tailored content objects, of a representation of a value based on an occurrence of a condition associated with the value.

5. The method according to claim 1, further comprising:
providing the translated consumer profile data to the user device at a first time;
receiving the translated consumer profile data from the user device at a second time after the first time; and
identifying, based on the translated consumer profile data, the at least one attribute in response to the receipt of the translated consumer profile data,
wherein obtaining the at least one content object for the consumer comprises obtaining the at least one content object based on the identification of the at least one attribute.

6. A system for delivering individually tailored content to a consumer anonymously, the system comprising:
one or more physical processors programmed with computer program instructions which, when executed, cause the one or more physical processors to:
collect consumer profile data associated with a consumer;
translate the consumer profile data into a usable but non-personally identifiable form, wherein the translated consumer profile data indicates one or more non-personally identifiable attributes related to the consumer profile data;
create one or more tailored content objects based on the one or more non-personally identifiable attributes indicated by the translated consumer profile data;
obtain at least one content object of the one or more tailored content objects for the consumer based on at least one attribute of the one or more non-personally identifiable attributes; and
provide the at least one content object to a user device associated with the consumer.

7. A method for delivering individually tailored content to a consumer anonymously, the method being implemented on a computer system that include one or more physical processors executing computer program instructions which, when executed, perform the method, the method comprising:
receiving, from a user device, translated consumer profile data, wherein the translated consumer profile data includes only non-personally identifiable data, and wherein the non-personally identifiable data indicates one or more non-personally identifiable attributes related to consumer profile data provided by a consumer associated with the user device;
obtaining one or more tailored content objects for the consumer based on the one or more non-personally identifiable attributes, wherein the one or more tailored content objects are created based on the one or more non-personally identifiable attributes and stored in a database prior to the receipt of the translated consumer profile data from the user device; and
providing the one or more tailored content objects to the user device.
